(19) United States
(12) Patent Application Publication
(10) Pub. No.: US 2007/0001515 A1
(43) Pub. Date: Jan. 4, 2007

(54) Supply of loads of different powers by a D.C./D.C. converter

(75) Inventors: Jerome Heurtier, Tours (FR); Arnaud Florence, Saint Antoine du Rocher (FR)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMicroelectronics SA, Montrouge (FR)

(21) Appl. No.: 11/436,116

(22) Filed: May 17, 2006

(30) Foreign Application Priority Data
May 18, 2005 (FR) 05/51287

(51) Int. Cl. H02J 3/14

(52) U.S. Cl. 307/31

(57) ABSTRACT

A power converter of switched-mode type for providing a voltage to several loads, a first load being of relatively low power with respect to the power of a second load. The converter comprises a circuit for generating cut-off pulses of a D.C. voltage. The converter comprises means for selecting an operating mode from among: a first operating mode in which only the first load of relatively low power is supplied and the circuit for generating cut-off pulses regulates a voltage supplied to the first load; and a second operating mode in which both the first and the second loads are supplied, the circuit for generating cut-off pulses regulates the voltage provided to the second load, the voltage being periodically provided to the first load for a time period which is relatively short with respect to a second time period, during the second time period the voltage is provided to the second load.

### BACKGROUND OF THE INVENTION

1. Field of the Invention

The present invention relates to the field of power converters and, more specifically, to D.C./D.C. converters of switched-mode type. The present invention especially applies to step-up converters intended to supply loads of different powers.

2. Description of the Related Art

FIG. 1 shows in the form of blocks an example of a system to which the present invention applies. It is an electronic device (DEV) 1 comprising or having to control at least two loads 10 (q) and 20 (Q) exhibiting different powers. Such loads may be of same nature (for example, lighting elements of light-emitting diode type) or of different nature (for example a lighting and a sound).

FIG. 2 very schematically shows a cellular phone 1 forming an exemplary application of the present invention. In this example, a first load of relatively low power is formed by screen 10 (DISPLAY) and more specifically by the light-emitting diodes (generally, white diodes) series-associated to form the display screen backlighting element. A load of relatively high power is formed, for example, of a flash-type light-emitting diode 20 (flash LED) intended to assist the shooting via an objective 2 comprised by the cellular phone. In FIG. 2, a keyboard 3 of the telephone has been illustrated.

Another exemplary application relates to digital photographic devices equipped with a display screen and with a flash-type diode.

The supply of loads of relatively high power generally requires raising the power supply voltage of the device (generally, a voltage provided by a battery). For bulk reasons, it is desired to supply the different loads with a single converter.

FIG. 3 shows a first conventional example of a D.C./D.C. converter for supplying several loads independent from one another.

A step-up converter provides, between an output terminal 31 and ground 32, a voltage Vout higher than a D.C. input voltage Vdc applied between an input terminal 33 and ground 32. Terminals 33 and 31 are connected to each other by an inductive element L in series With a diode D, the cathode of diode D being connected to terminal 31. The output voltage is sampled across a capacitor C grounding terminal 31. A cut-off switch M is connected between junction point 34 of inductance L and diode D and the ground. Switch M is controlled by a circuit 35 (for example, a pulse-width modulation control circuit, PWM CTRL), which provides pulses for turning on switch M according to an order OR and to a feedback signal FB. Block 35 also receives a clock signal f_{M} enabling it to generate the control pulses of switch M. The control performed by circuit 35 on the control pulses may be of pulse-width modulation type (PWM), frequency modulation type (FWM), etc.

In the example shown in FIG. 3, two loads 10 (q) and 20 (Q) are connected to terminal 31. Each of the loads is in series with a switch, respectively K1, K2, controlled by a signal A1, A2 to select the load 10 or 20 that must be supplied by voltage Vout. A resistor R1 or R2 respectively connects the switch of each of the loads to ground 2.

In a power converter such as illustrated in FIG. 3, the regulation of voltage Vout is only performed on one of the loads (that with the highest power). Signal FB is sampled from node 36 between load 20 and resistor R2 which is used as a current-to-voltage converter to control voltage Vout according to order OR. For the regulation to occur properly, resistors R1 and R2 must compensate for the impedance difference between the supplied loads 10 and 20. Such ballast resistors generate losses, which, especially in the application to loads of strongly different powers, are incompatible with the search for a reasonable consumption.

FIG. 4 shows a second conventional example of a power regulation intended to supply several loads. In this example, each load 10 (q), 20 (Q) is supplied by a capacitor C1, C2 which is specific thereto. The cathode of diode D is connected to each of capacitors C1, C2 via a switch K1 or K2, respectively, controlled by a signal A1 or A2. Power supply voltages Vout1 and Vout2 of loads 10 and 20 are respectively sampled across capacitors C1 and C2. Circuit 35′ for providing the train of control pulses of cut off switch M receives two control signals FB1 and FB2 respectively sampled across resistors R1 and R2, separately grounding each of loads 10 and 20.

This assembly enables independent regulation of each of the load supply voltages. However, it requires two full output voltage regulation loops.

Another known solution (not shown) comprises the use of a multiconverter combining a step-up converter with a charge pump circuit. A disadvantage of such a solution is its cost and the high number of required external components.

### BRIEF SUMMARY OF THE INVENTION

One embodiment of the present invention provides a voltage step-up power converter, of switched-mode type, which overcomes the disadvantages of known solutions. The power converter is a single step-up converter that supplies at least two loads of different power. The power converter enables the simultaneous operation of two loads.

One embodiment of the present invention provides an integrable solution.

One embodiment of the present invention provides a power converter of switched-mode type for providing a voltage to several loads, a first load being of relatively low power with respect to the power of a second load and the converter comprising a circuit for generating cut-off pulses of a D.C. supply voltage, comprising means for selecting an operation mode from among:

a first operating mode in which only the load of relatively low power is supplied and the circuit for generating cut-off pulses regulates the voltage supplied to this load; and

a second operating mode in which both loads are supplied, the pulse generation circuit regulating the voltage provided to the second load, this voltage being periodically provided to the first load for a first time period which is relatively short with respect to a second time period of provision of this voltage to the second load.

According to an embodiment of the present invention, each load is series-connected with a switch between a first terminal of provision of the output voltage and the ground, a capacitor being connected in parallel with each of the loads.

According to an embodiment of the present invention, a current-to-voltage conversion resistor is interposed between each load and the ground.

According to an embodiment of the present invention, a circuit for controlling the switches assigns to each of the loads its supply periods during the second operation mode.

According to an embodiment of the present invention, a current-limiting element is in series with the first load.

According to an embodiment of the present invention, the loads to be supplied are light-emitting diodes.

According to an embodiment of the present invention, the second load is a flash diode.

The present invention also provides a method for sharing a power converter between at least two loads of different powers, comprising, in periods when a supply of a load of relatively high power is required, the assigning to each of the loads of the periodical supply time periods, the time periods of supply of the load of relatively low power being short as compared with the time periods of supply of the load of relatively high power.

### BRIEF DESCRIPTION OF THE SEVERAL VIEWS OF THE DRAWINGS

The foregoing and other features and advantages of the present invention will be discussed in detail in the following non-limiting description of specific embodiments in connection with the accompanying drawings.

FIG. 1, previously described, shows a block diagram of an example of a system to which the present invention applies;

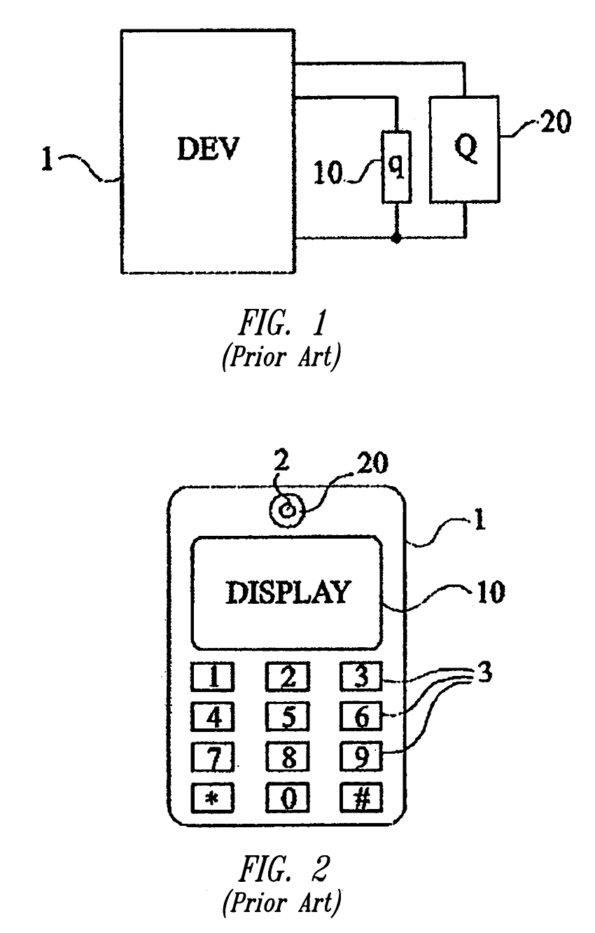

FIG. 2, previously described, shows a schematic illustration of a cellular phone equipped with a digital photographic device of the type to which the present invention applies according to an embodiment;

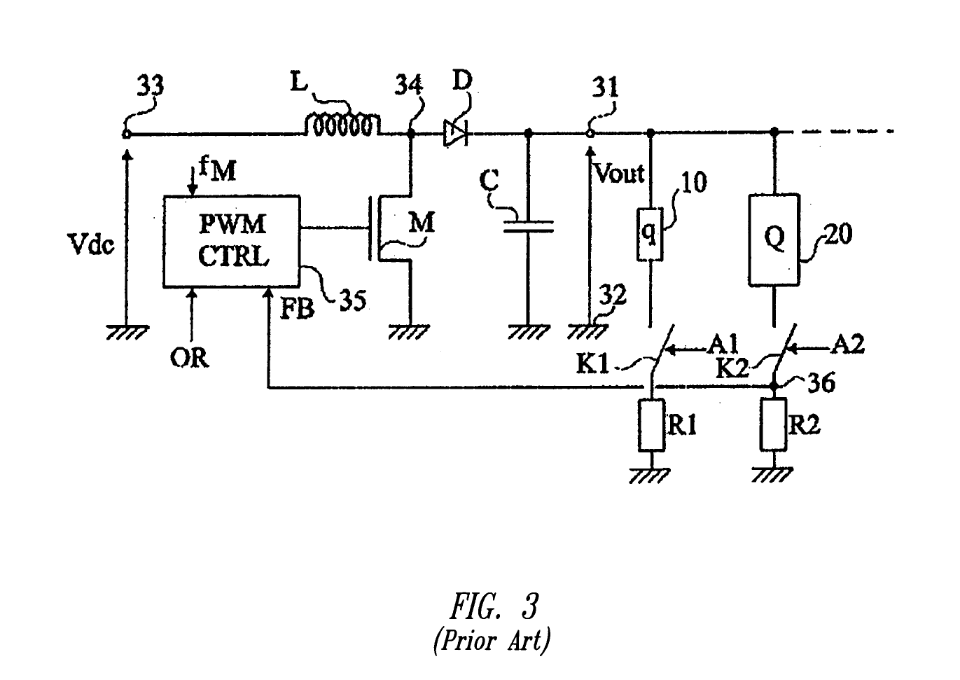

FIGS. 3 and 4, previously described, show the state of the art and the problem to solve;

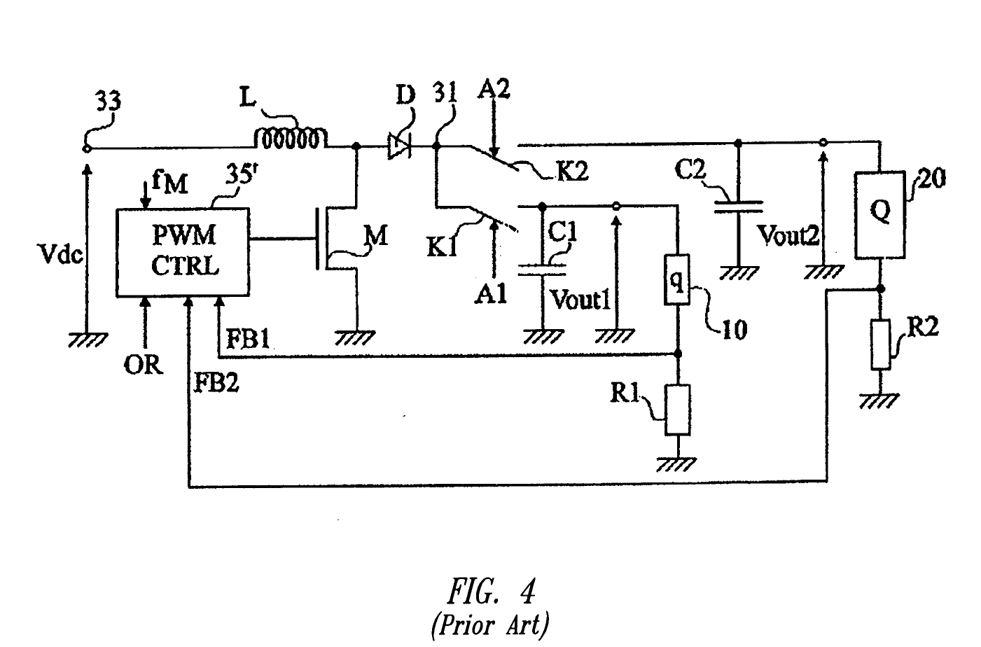

FIG. 5 partially shows an embodiment of a power converter according to the present invention;

FIGS. 6A and 6B are timing diagrams illustrating the operation of the converter of FIG. 5;

FIG. 7 partially shows a detail of a circuit for controlling a power converter according to one embodiment of the present invention.

### DETAILED DESCRIPTION OF THE INVENTION

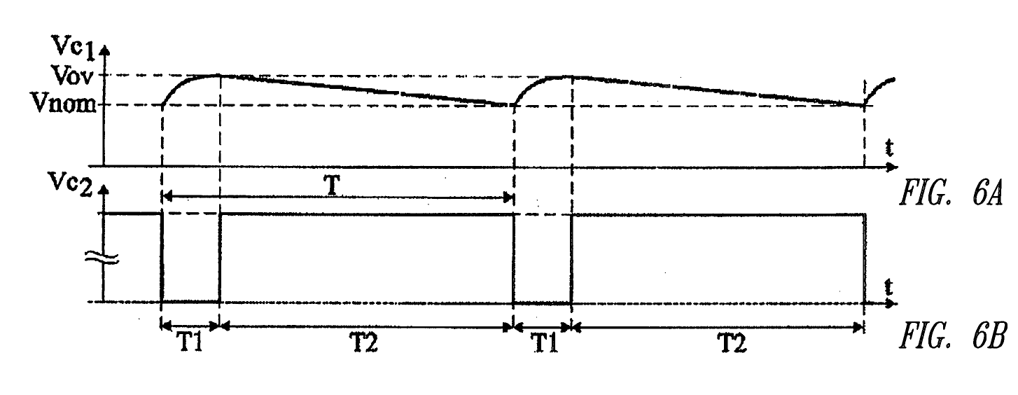

Same elements have been designated with same reference numerals in the different drawings and the timing diagrams of FIGS. 6A and 6B and have been drawn out of scale. For clarity, only those elements which are useful to the understanding of the present invention have been shown in the drawings and will be described hereinafter. In particular, the circuit generating pulse trains for controlling the cut-off switch has not been detailed, the present invention being compatible with the use of any conventional pulse train generation circuit.

The present invention will be described in relation with an example of application to a voltage step-up converter intended to supply at the same time screen backlighting diodes and one or several flash-type diodes. However, it more generally applies to any step-up converter intended to supply two loads of different powers. For example, the case in point may be to generate visual and sound signals, a flashlight equipped with a flash function, etc.

The present invention originates from a novel analysis of the use of loads of different powers in applications where, in the lifetime of the full device, the loads of relatively high power are used episodically with respect to the loads of relatively low power. For example, in the case of a cellular phone with a photo function, the backlit screen is used almost permanently (from as soon as the telephone no longer is in standby mode) while the flash is likely to be used episodically in a shooting requiring additional lighting.

Further, in the applications aimed at by the present invention, the use of loads of relatively high power is of short duration as compared with the use of loads of relatively low power. For example, in the case of a cellular phone with a backlit screen and with a flash, the need for a time control of the flash is smaller than 100 μs for each shooting. The intensity required by the flash however is of several hundreds of milliamperes (for example, on the order of 300 milliamperes) which are to be compared with the few tens of milliamperes (typically, on the order of 20 milliamperes) which are enough to supply light-emitting diodes in series ensuring the screen backlighting function.

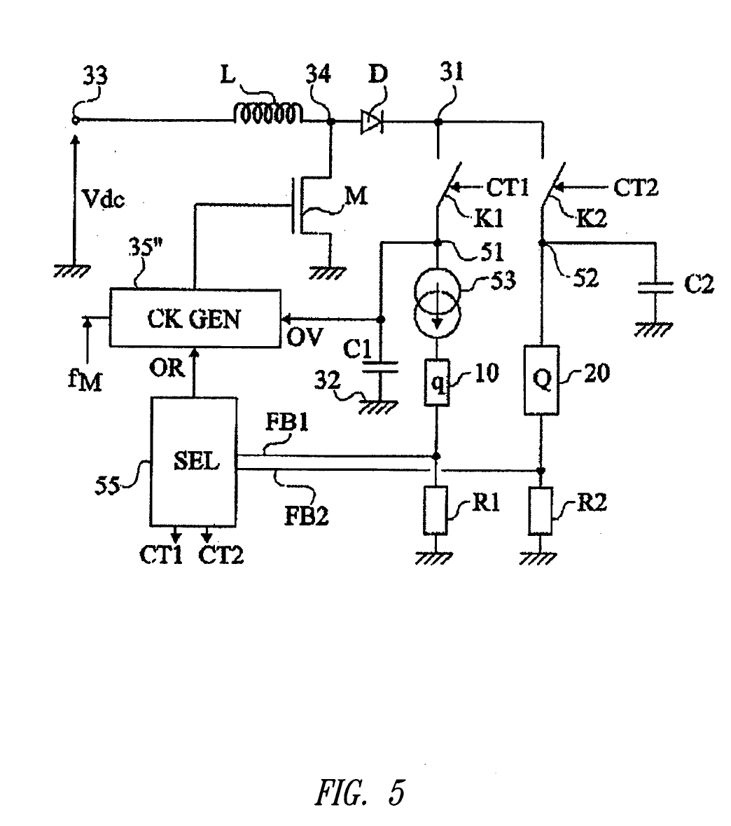

FIG. 5 shows a partial schematic illustration of an embodiment of a power converter according to the present invention.

The power conversion circuit of FIG. 5 uses many of the same components as the conventional circuit of FIG. 4. Thus, a cut-off switch M is connected to junction point 34 of an inductive element L with a diode D between a terminal 33 of application of a D.C. input voltage Vdc and a terminal 31 likely to be connected to ground 32 by a capacitor.

According to this embodiment of the present invention, each load 10 (q) or 20 (Q) is series-connected with a switch K1 or K2 between terminal 31 and a grounded current-to-voltage conversion resistor R1 or R2. Preferably, a current-limiting element 53 is interposed between switch K1 and load 10 of relatively low power.

A first storage capacitor C1 connects junction point 51 of switch K1 and element 53 to ground 32. A second storage capacitor C2 connects junction point 52 of switch K2 and load 20 to ground.

A pulse supply circuit 35″ (CKGEN) comprises an input for receiving an order signal OR for the value of the desired output voltage, an input for receiving a signal OV for detecting a possible overload on capacitor C1, and an input for receiving a clock signal f_{M} of relatively high frequency (generally several hundreds of kilohertz).

According to this embodiment of the present invention, order signal OR is provided by a circuit 55 (SEL) for selecting one operating mode out of two according to whether load 20 of relatively high power is desired or not. Circuit 55 receives information FB1 and FB2 relative to the respective currents in loads 10 and 20. Signals FB1 and FB2 for example are voltages sampled across current-to-voltage resistors R1 and R2. Circuit 55 also provides signals CT1 and CT2 for respectively controlling switches CT1 and CT2. As a variation, circuits 35″ and 55 are one and the same circuit.

In a first operation mode, load 20 is not used. Switch K2 is then off and switch K1 is on. Circuit 35″ regulates the voltage across capacitor C1 by preferably exploiting information FB1 sampled across resistor R1.

In a second operation mode where load 20 is to be supplied, circuit 55 alternately turns on switches K1 and K2 with a frequency (for example, ranging between a few hundreds of hertz and a few tens of kilohertz) which is low as compared to the frequency of several tens, or even hundreds of kilohertz for controlling cut-off switch M. The on periods of switch K2 are large as compared with the off periods of switch K1. During this operation mode, capacitor C1 is periodically charged and is used as a supply tank of load 10 while switch K2 is on. The regulation of the control pulse train of switch M is performed based on signal FB2 representative of the voltage across capacitor C2.

FIGS. 6A and 6B illustrate, in an example of shape of respective voltages VC1 and VC2 across capacitors C1 and C2, the second operation mode of a converter such as illustrated in FIG. 5.

During a period T, long as compared with the period of the control pulses of switch M, switch K1 is on for a time period T1, short as compared with time period T2 when switch K2 is on. For example, switch K1 is turned on at each beginning of a period T for a time T1 ranging between 5% and 30% of period T, switch T2 being on for the rest (from 95% to 70%) of period T.

Capacitor C1 is charged with a voltage Vov greater than the voltage level required by load 10 (especially as compared with the size sufficient for the first operation mode) to be able to provide a voltage Vnom sufficient for a proper operation of load 10 during periods T2 of activation of load 20. During periods T2, load 10 is supplied by the discharge of capacitor C1.

During the second operation mode, current limiter 53 then enables maintaining the current constant in the load and dissipates the additional power. Such losses however remain acceptable since, on the one hand, the periods when this second operation mode is activated are, during the product lifetime, scarce with respect to the normal operation periods (first mode) where only load 10 is used and, on the other hand, the power ratio between loads 10 and 20 results in that the amount of power required to supply load 10 during period T2 remains relatively low.

Preferably, the charge voltage level of capacitor C1 is measured (signal OV) for, if need be, interrupting the turn-on pulses of switch M until the end of time period T1. This is used on the one hand, to protect load 10 against a possible detrimental overvoltage and, on the other hand, to limit losses linked to the controlled overvoltage (between Vnom and Vov).

As a variation, signal OV is sent to circuit 55 which, in period T, controls the switching time between switches K1 and K2.

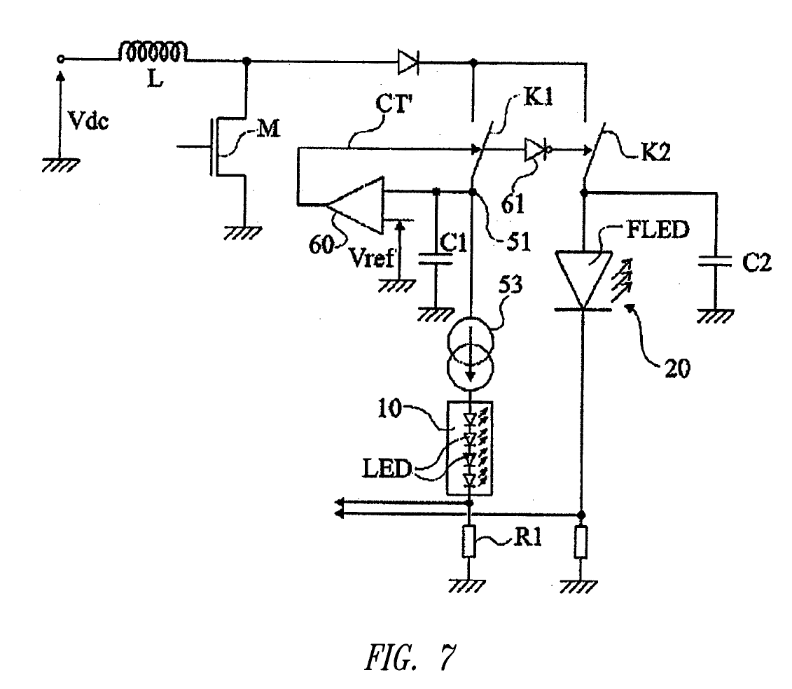

FIG. 7 shows an example of the forming of a portion of circuits 35″ and 55 specific to the second operation mode. For simplification, not all the elements have been shown in FIG. 7. Load 10 has been illustrated in the form of four light-emitting diodes LED in series between current-limiting element 53 and resistor R1. Load 20 has been illustrated in the form of a flash light-emitting diode FLED.

According to the embodiment of FIG. 7, switches K2 and K1 are controlled to be turned off by a same signal CT′ provided by a comparator 60 of the voltage across capacitor C1 with respect to a reference voltage Vref. This reference voltage is selected according to the desired level Vov (FIG. 6A). An inverter 61 is interposed between the control terminals of switches K1 and K2 to invert the control. The representation of FIG. 7 is functional. In practice, it will be avoided for switches K1 and K2 to have a risk of being simultaneously on.

An advantage of the embodiment of FIGS. 5 and 7 is that it enables simultaneously supplying loads of low power and of high power by means of a same converter.

Another advantage is that, since the respective durations of voltage provision to the loads are greater than the durations of the cut-off pulses (control frequency of switches K1 and K2 low with respect to the control frequency of switch M), a single regulation loop is sufficient.

Another advantage is that it limits power losses.

Of course, the present invention is likely to have various, alterations, improvements, and modifications which will readily occur to those skilled in the art. In particular, although the present invention has been described hereabove in relation with an application to light-emitting diodes, it more generally applies to the control of various loads (for example, of sound or visual warning type) provided for the periods of use of the load(s) of relatively high power to be low with respect to the periods of use of the load(s) of relatively low power.

Further, the practical implementation of the present invention based on the functional indications given hereabove and in particular the sizings to be given to the different components are within the abilities of those skilled in the art.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

We claim:

1. A power converter of switched-mode type for providing a voltage to first and second loads, the first load being of relatively low power with respect to a power of the second load, the power converter comprising:
a pulse generation circuit for generating cut-off pulses of a D.C. supply voltage; and
means for selecting an operating mode from among:
a first operating mode in which only the first load of relatively low power is supplied and the pulse generation circuit regulates the voltage supplied to the first load, and
a second operating mode in which both the first and the second loads are supplied, the pulse generation circuit regulating the voltage provided to the second load, the voltage being periodically provided to the first load for a first time period which is relatively short with respect to a second time period, during which the voltage is provided to the second load;
a first switch connected with the first load between an output terminal and a ground terminal; and
a second switch connected with the second load between the output terminal and the ground terminal.

2. The converter of claim 1, further comprising:
a first capacitor connected in parallel with the first load; and
a second capacitor connected in parallel with the second load.

3. The converter of claim 2, further comprising:
a first current-to-voltage conversion resistor interposed between the first load and the ground terminal; and
a second current-to-voltage conversion resistor interposed between the second load and the ground terminal.

4. The converter of claim 2, further comprising a circuit for controlling the first and second switches that are structured to assign to the first and second loads the first and second time periods, respectively, for supplying voltage to the respective loads during the second operating mode.

5. The converter of claim 2, further comprising a current-limiting element in series with the first load.

6. The converter of claim 1, wherein the first and second loads are light-emitting diodes.

7. The converter of claim 6, wherein the second load is a flash light-emitting diode.

8. The converter of claim 1, wherein the pulse generation circuit includes an overvoltage detector that detects an overvoltage condition of the first load and temporarily stops the cut-off pulses in response to detecting the overvoltage condition.

9. The converter of claim 9 wherein the overvoltage detector includes a capacitor connected in parallel with the first load.

10. A method for sharing a power converter between at least first and second loads of different powers, the second load having a higher power than the first load, the method comprising,
assigning to the first load a first supply time period during which the converter supplies power to the first load; and
assigning to the second load a second supply time period during which the converter supplies power to the second load, the second supply time period being long compared with the first supply time period.

11. The method of claim 10, further comprising controlling first and second switches that are structured to assign to the first and second loads the first and second time periods, respectively, for supplying voltage to the respective loads during the second operating mode.

12. The method of claim 10, further comprising detecting an overvoltage condition of the first load and temporarily stopping the supply of power in response to detecting the overvoltage condition.

13. A power converter comprising:
a first load;
a second load having a power consumption that is greater than the first load;
a supply voltage;
a cut-off switch to selectively generate voltage pulses from the supply voltage;
an overvoltage detector coupled to the first load and structured to produce an overvoltage signal in response to detecting an overvoltage condition; and
a pulse supply circuit coupled to the overvoltage detector and structured to control the cut-off switch based upon the overvoltage signal and a selection signal indicating a selected operating mode.

14. The power converter of claim 13 wherein the selected operating mode is one of a first or a second operating mode, the first operating mode in which the first load is supplied with the voltage pulses and the pulse supply circuit regulates the voltage pulses supplied to the first load, the second operating mode in which both the first and the second loads are supplied with the voltage pulses and the pulse supply circuit regulates the voltage pulses supplied to the second load.

15. The power converter of claim 14 wherein the voltage pulses of the second operating mode are periodically supplied to the first load for a first time period and to the second load for a second time period which is greater than the first time period.

16. The power converter of claim 13 wherein the overvoltage detector includes a first capacitor connected in parallel with the first load.

17. The power converter of claim 16, further comprising:
a first switch connected with the first load between an output terminal and a ground terminal;
a second switch connected with the second load between the output terminal and the ground terminal; and
a second capacitor connected in parallel with the second load.

18. The power converter of claim 13, further comprising means for providing the selection signal indicating the selected operating mode.

19. The power converter of claim 18 wherein the means for providing the selection signal is included within the pulse supply circuit.
